(19) United States
(12) Patent Application Publication
(10) Pub. No.: US 2015/0310546 A1
(43) Pub. Date: Oct. 29, 2015

(54) PROVIDING A LOAN DISCOUNT ON PROPERTY IN CONNECTION WITH THE PURCHASE OF AN INSURANCE PRODUCT

(71) Applicant: State Farm Mutual Automobile Insurance Company, Bloomington, IL (US)

(72) Inventors: Leif A. Roll, Bloomington, IL (US); Jun Wu, Bloomington, IL (US)

(21) Appl. No.: 14/261,648

(22) Filed: Apr. 25, 2014

(51) Int. Cl. G06Q 40/02; G06Q 30/02

(52) U.S. Cl. CPC G06Q 40/025; G06Q 30/0222; G06Q 40/08

(57) ABSTRACT

Providing a discount for an interest rate on a loan in connection with the purchase of an insurance product. The insurance product may protect property purchased by the loan from loss. The loan applicant may be a new customer of the provider of the insurance product and the interest rate discount is an incentive for the customer to purchase a loan product.

### TECHNICAL FIELD

The present invention relates generally to systems and methods for automatically providing a discount on an interest rate for a loan for purchasing property in connection with purchasing an insurance product.

### BACKGROUND

Insurance policies allow consumers to protect against the loss of life or property. For example, a person purchases insurance to cover loss of or damage to his or her automobile. In exchange for the payment of insurance premiums to an insurance provider, the provider agrees to compensate the policy holder in the event of a loss of or damage to the covered property. The covered property can include an automobile, a motorcycle, a recreational vehicle, a boat, or a house or any other property that can be protected by an insurance policy.

Often, a consumer will take out a loan to purchase property that is covered by insurance. During the loan application process, this consumer would be a “loan applicant.” This situation occurs because property for which a consumer buys insurance typically has a high purchase cost. This high price is a reason for insuring the property, so that the consumer can reduce his or her risk of losing money in case the property is damaged or stolen. Similarly, the purchased property often is used to secure the loan. That is, the financial institution that provides the loan to the consumer to purchase the property often places a lien on the property so that the financial institution can take ownership of the property should the consumer default on the loan. Often, the financial institution will require the consumer to insure the property to reduce the financial institution's risk of a default where the property cannot be used to recover the balance remaining on the loan.

An insurance provider, as with most businesses, seeks to attract and retain new customers, including attracting customers away from a competitor insurance provider. One thing that may factor into a consumer's decision to become a new customer or remain a customer of an insurance provider is the presence of financial incentives for becoming and remaining a customer.

Financial institutions are positioned in the marketplace to be aware of when a customer purchases property that requires a loan (and insurance), since the financial institution provides the loan. Insurance providers are similarly positioned in the marketplace to be aware of when a customer purchases property that often requires a loan, since those customers seek insurance coverage for the property. Accordingly, a financial institution and insurance provider are uniquely positioned to work together to provide a discounted interest rate on a loan in connection with selling an insurance product. In one case, the financial institution may be part of a larger company that includes both an insurance provider and a financial institution. This case may include the situation were a financial institution owns an insurance provider subsidiary or vice versa. In a second case, the insurance provider may have a business relationship with one or more financial institutions that are independent of the insurance provider, where the business relationship includes the financial institution providing leads to the insurance provider on potential customers. In a third case, a financial institution may establish a relationship with one or more insurance providers for the purpose of receiving notifications that a customer is seeking insurance on newly-purchased property. This working relationship between a financial institution and insurance provider presents opportunities for the insurance provider to provide customers with financial incentives in return for purchasing insurance products, including a discount on the interest rate for a loan.

What is needed is an automated system and method for providing a loan discount for property in connection with purchasing an insurance product for the property to provide financial incentives for new or existing customers of the insurance provider.

### SUMMARY OF THE INVENTION

The present invention includes systems and methods for automatically providing a loan discount for property in connection with purchasing an insurance product for the property. In one aspect of the present invention, a computer-based method for automatically providing a discounted interest rate for a loan is provided. The computer-based method includes the steps of: 1) determining an interest rate discount for the loan based on a loan applicant purchasing an insurance product; 2) determining the interest rate for the loan based on the creditworthiness of the loan applicant and the determined interest rate discount; 3) making an underwriting decision based on the determined interest rate; 4) if the loan is approved, determining a periodic payment amount based on the determined interest rate; and 5) administering the loan, including periodically confirming that the purchased insurance product is still in force and recalculating the payment amount without considering the interest rate discount if the purchased insurance product is not in force.

In another aspect of the present invention, a computer-based system for automatically providing a discounted interest rate for a loan, is provided. The system includes an installment loan application module programmed to: 1) determine an interest rate discount based on a loan applicant purchasing an insurance product; 2) determine the interest rate for the loan based on the creditworthiness of the loan applicant and the determined interest rate discount; 3) make an underwriting decision based on the determined interest rate; and 4) determine a periodic payment amount based on the determined interest rate; and a loan system module programmed to: 1) administer the loan, comprising periodically confirming that the purchased insurance product is still in force and recalculating the payment amount without considering the interest rate discount if the purchased insurance product is not in force.

In yet another aspect of the present invention, a computer-based method for automatically providing a discounted interest rate for a loan is provided. The computer-based method includes the steps of: 1) providing a first interface for receiving information from a loan applicant; 2) receiving data comprising information for a loan application for the loan provided by the loan applicant; 3) determining an interest rate discount based on the loan applicant purchasing an insurance product; 4) determining the interest rate for the loan based on the creditworthiness of the applicant and the determined interest rate discount; 5) making an underwriting decision based on the determined interest rate; 6) if the loan is approved, determining a periodic payment amount based on the determined interest rate; 7) providing a second interface for informing the loan applicant about the status of the loan; and 8) administering the loan, comprising periodically confirming that the purchased insurance product is still in force and recalculating the payment amount without considering the interest rate discount if the purchased insurance product is not in force.

### BRIEF DESCRIPTION OF THE DRAWINGS

FIG. 1 provides a diagram depicting a computer network in accordance with an exemplary embodiment of the present invention.

FIGS. 2a and 2b provide diagrams depicting software architecture in accordance with an exemplary embodiment of the present invention.

FIG. 3 provides a flow diagram depicting the process flow for providing a discounted loan in connection with an insurance product in accordance with an exemplary embodiment of the present invention.

FIG. 4 provides a flow diagram depicting the process flow for making an underwriting decision associated with providing a discounted loan in connection with an insurance product in accordance with an exemplary embodiment of the present invention.

FIG. 5 provides a flow diagram depicting the process flow for determining a loan discount associated with providing a discounted loan in connection with an insurance product in accordance with an exemplary embodiment of the present invention.

FIG. 6 provides a flow diagram depicting the process flow for maintaining a loan associated with providing a discounted loan in connection with an insurance product in accordance with an exemplary embodiment of the present invention.

### DETAILED DESCRIPTION

The exemplary embodiments of the present invention provide systems and methods for providing a loan discount for a loan used to purchase property in connection with purchasing an insurance product. More specifically, the present invention provide systems and methods for automatically delivery and administering a loan discount for a loan used to purchase property in connection with the loan applicant purchasing insurance for that property or purchasing another unrelated insurance product.

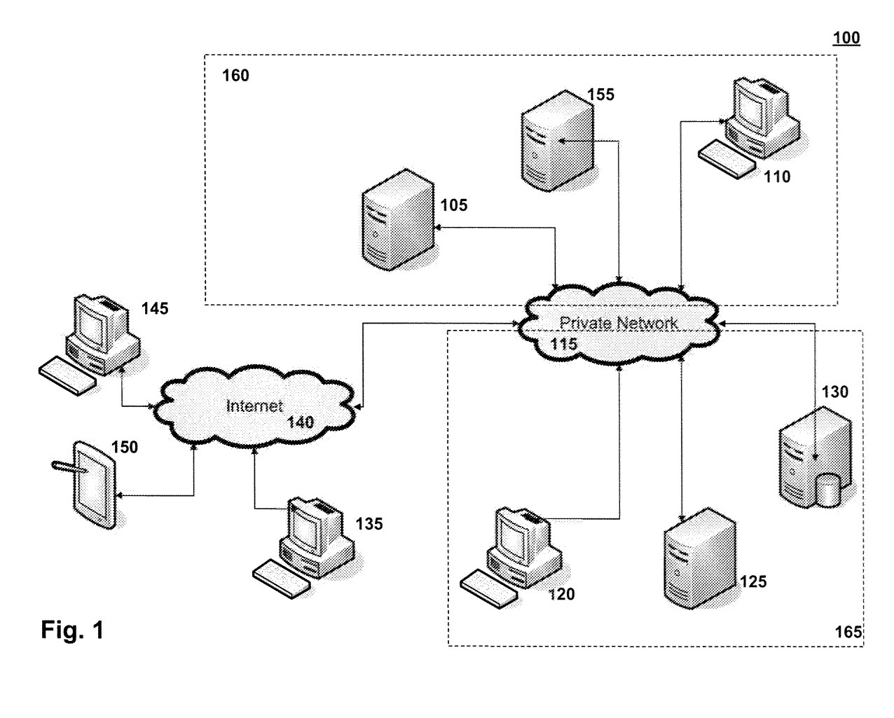

FIG. 1 depicts a computer network 100 in accordance with an exemplary embodiment of the present invention. Referring to FIG. 1, a loan processing computer 105 is operable to process loan applications and maintain ongoing loans for customers of a financial institution. The loan processing computer is connected to other computers over a computer network, such as a private computer network 115 or the Internet 140. The private computer network 115 may be a local area network (LAN) or wide area network (WAN). Connections over the Internet 140 may be accomplished through virtual private network (VPN) protocols or other known secure connections. These other computers can be used to enter information used in processing a loan on the loan processing computer 105 or to configure software resident on the loan processing computer 105.

The loan processing computer 105 is connected to a loan processing workstation 110. A user uses the loan processing workstation 110 to access the loan processing computer 105, such as for entering information used in processing a loan, reviewing the status of the loan process, or configuring software resident on the loan processing computer 105. The loan processing workstation 110 can also be used to access other computers attached to the private network 115 or the Internet 140.

The loan processing computer 105 is also connected to a financial institution computer 155. The financial institution computer 155 manages financial accounts for its customers. The loan processing computer 105, loan processing workstation 110, and financial institution computer 155 (and, possibly, other computers, not shown) form a financial institution sub-network 160. In an alternative embodiment, the loan processing computer 105 and loan processing workstation 110 are resident on a network separate from the financial institution computer 155. For example, a vendor may provide loan processing services to a financial institution. In that case, the loan processing computer 105 and loan processing workstation 110 would be connected to the financial institution computer 155 over the Internet 140 or through a direct connection, such as a direct communications line between the vendor and the financial institution.

An insurance processing computer 125 is connected to the private network 115. The insurance processing computer 125 is used in providing insurance products to customers of an insurance provider. For example, the insurance processing computer 125 provides workflow information for an insurance agent of the insurance provider operating an insurance workstation 120, which is connected to the insurance processing computer 125 by the private network 115. The agent uses the insurance workstation 120 to work items in his or her workflow. Workflow items can include requests for insurance products, insurance claim follow-up, and other activities covering interactions between an agent and a customer or potential customer of the insurance provider.

The insurance processing computer 125 is also connected to one or more other computers, such as an insurance database server 130. The insurance database server 130 includes data files with information on customers, including personal identifying information and insurance products and services purchased by the customer. The insurance processing computer 125, insurance workstation 120, and insurance database server 130 (and, possibly, other computers, not shown) form an insurance provider sub-network 165. As seen in the exemplary network architecture of FIG. 1, the components of the insurance provider sub-network 165 are connected to components of the financial institution sub-network 160 through a private network 115, such as may be the case for an insurance provider and financial institution that are part of the same company. In an alternative embodiment, the components of the insurance provider sub-network 165 are connected to components of the financial institution sub-network 160 through a public network such as the Internet 140, such as may be the case when the insurance provider and financial institution have a contractual, rather than corporate, relationship.

Customers may access components on the financial institution sub-network 160 or insurance provider sub-network 165 through a connection to the Internet 140 using a personal computer 145 or other computing device, such as a smartphone or kiosk (not shown) or tablet computer 150. For example, a customer may be able to apply for financial services, including a loan, from the financial institution or insurance products from the insurance provider by accessing the financial institution sub-network 160 or insurance provider sub-network 165 through the Internet 140. Also, an independent agent of the insurance provider may connect to the insurance processing computer 125 through a personal computer 135 connected to the Internet 140.

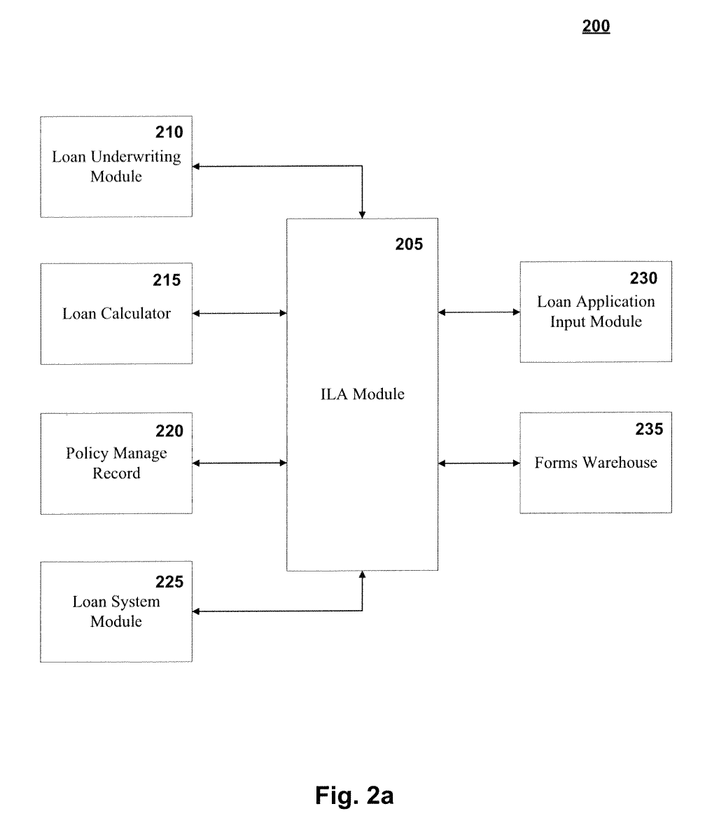

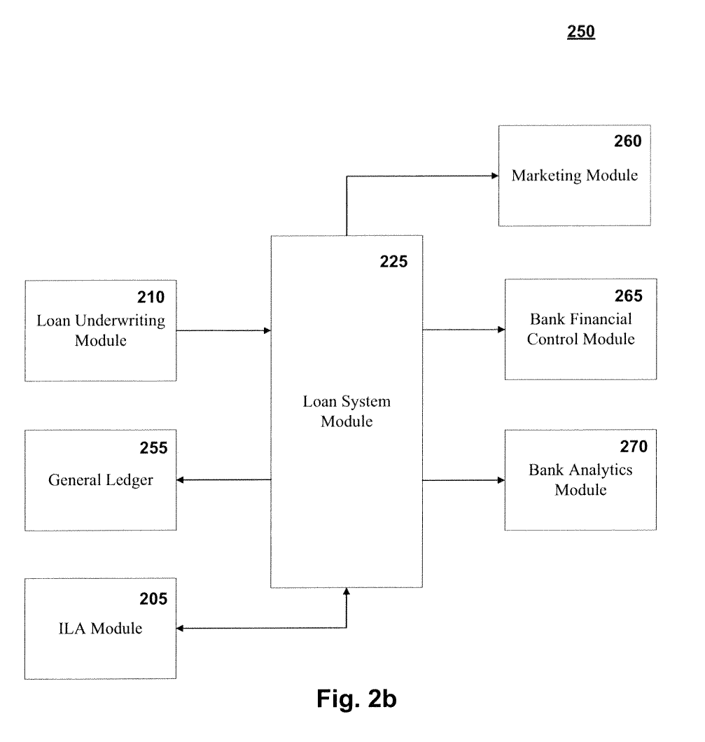

FIGS. 2a and 2b provide diagrams depicting software architectures 200 and 250 in accordance with an exemplary embodiment of the present invention. The depicted software architectures 200 and 250 are exemplary and the functions of specific modules discussed below could be performed by other modules (including modules identified in the architectures 200 and 250 or other modules not identified). Referring to FIGS. 1, 2a, and 2b, an installment loan application (ILA) module 205 is connected to additional software modules. The ILA module 205 processes applications for installment loans. Exemplary installment loans include auto or other vehicle loans, boat loans, and mortgages. The ILA module 205 is resident on the loan processing computer 105.

The ILA module 205 receives information concerning a loan application from a loan application input module 230. The loan application input module 230 includes a user interface that allows for inputting information necessary to complete a loan application. Such information includes personal identifying information about the borrower, credit history of the borrower, assets and liabilities of the borrower, and information about the property to be purchased (or, alternatively, refinanced) with the loan. Also, the loan application input module 230 may receive loan application input data from another computer program. For example, a software program (not shown) resident on a web server (not shown) could collect information and transfer the information to the loan application input module 230. In another example, an agent using the insurance workstation 120 may gather loan application data from a customer and input that data into a program resident on the insurance processing computer 125, which in turn transfers the data to the loan application input module 230. In one embodiment, a copy of the loan application input module 230 resides on the insurance processing computer 125, which is accessed by the agent using the insurance workstation 120.

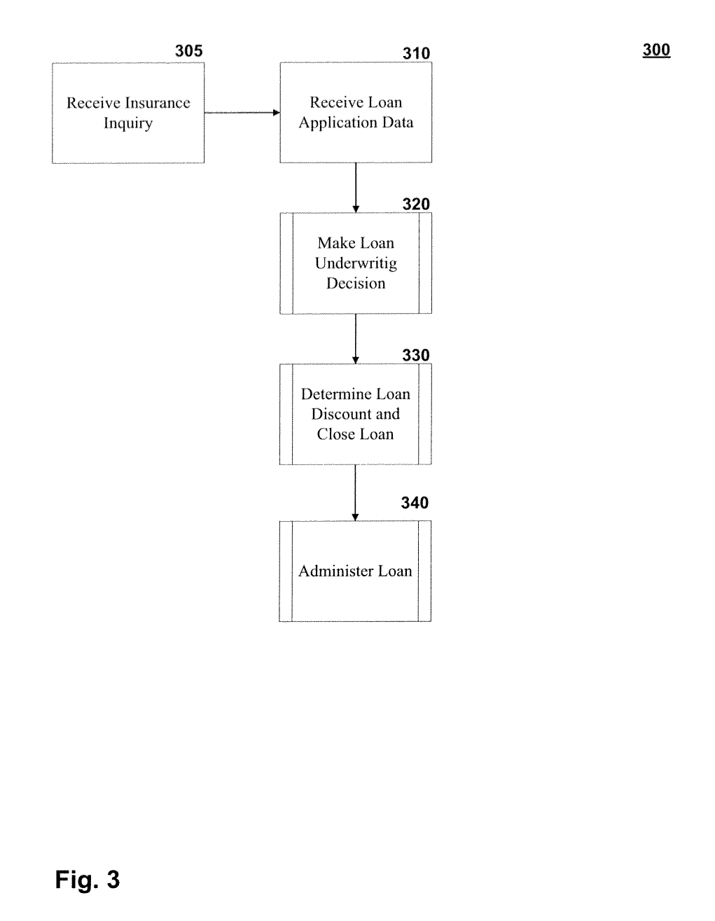

One piece of information that the ILA module 205 may receive from the loan application input module 230 is whether the customer qualifies for a loan discount for a loan covering property purchased or to be purchased by the customer (or the ILA module 205 may determine if the customer qualifies for a discounted interest rate). As is discussed in greater detail below in connection with FIGS. 3-6, under certain situations, a customer may qualify for a discount on a loan. One situation may be that the customer is a new insurance customer of an insurance provider purchasing insurance to cover property that is purchased with funds from a loan and, for as long as the customer keeps the insurance, the customer gets a discount on the interest rate for the loan.

As one example, a company has both a financial institution subsidiary and an insurance provider subsidiary. Customer A comes to the financial institution subsidiary seeking a loan for a new car. Customer A is not a customer of the insurance provider subsidiary. Customer A is given the opportunity for a reduced interest rate on the loan, such as 25 basis points, if Customer A switches his or her auto insurance to the insurance provider subsidiary. In a variation of this example, if Customer A currently has his or her auto insurance with a specific competitor, then Customer may be offered an increased incentive, such as a 50-basis-point reduction in the interest rate, to switch from the competitor to the insurance provider subsidiary.

In another example, Customer A may have auto insurance with the insurance provider subsidiary and seek a loan from the financial institution subsidiary on a new automobile. Customer A would not be eligible for a loan discount as a new auto policy customer. However, Customer A may be able to get a loan discount if he or she purchases a new insurance policy other than an auto insurance policy, such as an insurance policy on an existing house.

The above examples are based on a company that has both a financial institution subsidiary and an insurance provider subsidiary. The same scenarios could exist where an insurance provider has a contractual relationship with one or more financial institutions, where the financial institutions do not have a corporate relationship with the insurance provider. In this situation, the insurance provider contracts with the financial institutions to receive leads on financial institution customers seeking loans to purchase property, such as a house, vehicle, or boat. Through the relationship between the insurance provider and financial institution, a financial institution customer could receive a discount on the interest rate for a loan to purchase property if that customer purchases insurance for the property from the insurance provider, particularly if the customer would be a new customer for the insurance provider.

The ILA module 205 receives loan document forms from a forms warehouse 235 in response to a request by the ILA module 205 to the forms warehouse 235. These loan document forms are populated with data received from the loan application input module 230 and other data sources as part of the loan processing operation. One such additional data source may be one or more credit bureaus (not shown). For example, the ILA module 205 may interact with a credit bureau, such as TRANSUNION®, EXPERIAN®, or EQUIFAX®. A credit bureau collects and aggregates information related to a consumer's credit activity, such as payment history, debts, and court records. Typically, these credit bureaus calculate a credit score for a consumer based on the collected and aggregated data. The credit score, derived from an algorithm employed by the credit bureau, reflects the relative credit-worthiness of the consumer. Companies, such as insurance companies, can, for a fee, access a consumer's credit score and other credit data from the credit bureau.

The ILA module 205 interacts with a loan underwriting module 210. The loan underwriting module 210 is a decision and pricing engine that processes the loan application data to approve the loan. The ILA module 205 provides application and credit information to the loan underwriting module 210. The loan underwriting module 210 returns a loan approval (or denial) decision and a loan rate assignment to the ILA module 205. The loan underwriting module 210 applies known algorithms to evaluate the loan application data and credit information to determine the creditworthiness of the applicant. Rates are set based, in part, on the risk of repayment of the loan posed by the applicant, based on the evaluated data. The loan underwriting module 210 may reside on the loan processing computer 105. In an alternative embodiment, the loan underwriting module 210 may reside on a computer (not shown) operated by a vendor of loan analytical services. As part of its analytics, the loan underwriting module 210 may interact with one or more credit bureaus (not shown). This interaction would be instead of an interaction by the ILA module 205.

The ILA module 205 interacts with a loan calculator 215. The ILA module 205 sends the loan calculator 215 the approval and rate information received from the underwriting module 210. With this information, the loan calculator 215 calculates loan payment information. For example, the ILA module 205 supplies the loan calculator 215 the loan amount, loan duration, and interest rate. The loan calculator 215 returns the monthly payment for the loan. The loan calculator 215 may reside on the loan processing computer 105.

The ILA module 205 interacts with a policy manage record 220. The policy manage record 220 includes the status of an insurance policy. The ILA module 205 queries the policy manage record 220 for the status of a policy based on a unique identifier, such as a unique customer ID, a policy number, or vehicle identification number. The policy manage record 220 returns the status of any associated insurance policies. The policy manage record 220 resides on a computer on the insurance provider sub-network 165, such as the insurance database server 130.

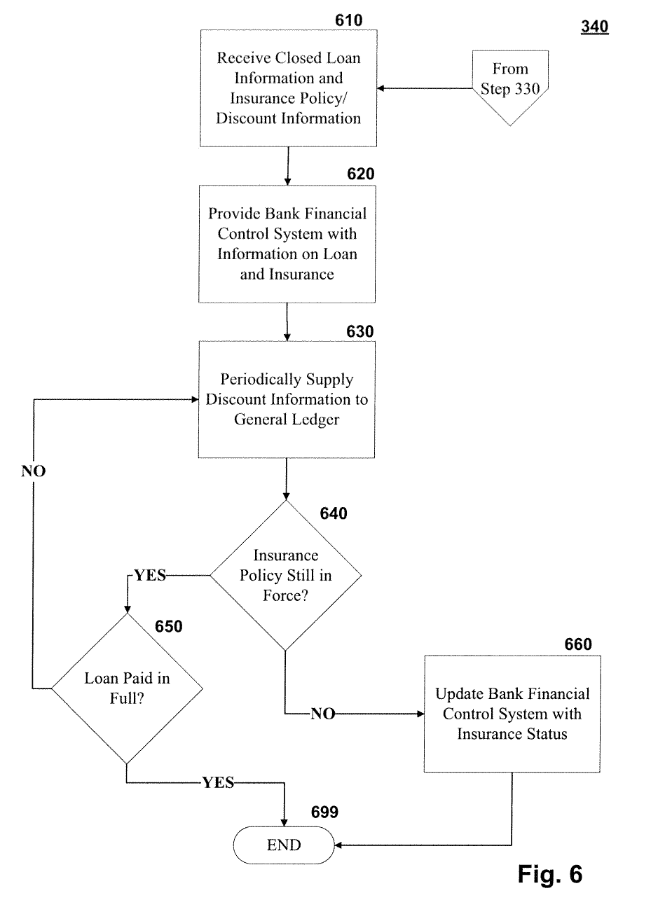

The ILA module 205 interacts with a loan system module 225. The loan system module 225 manages a loan once the loan is closed, that is, once all the approvals have been obtained for a loan and the customer signs the loan papers. The ILA module 205 sends the loan system module 225 any discounted interest rate that was applied to the loan and the policy number for the insurance policy that serves as the basis for the discount. In this exemplary embodiment, the customer receives the discounted interest rate only for as long as he or she maintains the insurance policy. As is described in greater detail below in connection with FIG. 6, the loan system module 225 periodically confirms that the insurance is still in place, that is, that the customer has not canceled the insurance policy with the insurance provider in favor of a different insurance provider. If the insurance is no longer in place, the discount is removed and interest rate adjusted accordingly. The policy information and discount information is used for this confirmation and, if necessary, adjustment. The loan system module 225 resides on the loan processing computer 105.

As seen in FIG. 2b, the loan system module 225 interacts with the loan underwriting module 210. The loan system module 225 receives information on the closed, or “booked,” loan from the loan underwriting module 210. The loan system module 225 also interacts with a general ledger 255. The loan interest rate discount is given to a customer as an incentive to purchase (and retain) an insurance product from an insurance provider. The insurance provider provides this incentive in return for the opportunity to service a new customer or to sell additional insurance products to an existing customer. However, the financial institution ultimately provides the incentive to the customer, in the form of a reduced monthly payment on a loan. Accordingly, the financial institution essentially loses money from each loan payment associated with the loan discount. Since the ultimate beneficiary of the discount program is the insurance provider, this loss is covered by the insurance provider, which pays the financial institution a sum to cover the difference in a loan payment associated with the discounted interest rate. The loan system module 225 tracts the money owned by the insurance provider to the financial institution by placing entries into the general ledger 255.

The loan system module 225 interacts with the ILA module 205 during maintenance of the loan to verify that the insurance policy that serves as the basis for the discount is still in place. In response to this query, the ILA module 205 queries the policy manage record 220, using a unique customer ID, a policy number, vehicle identification number, or the like as supplied by the loan system module 225, to receive status information on the insurance policy from the policy manage record 220.

Further, the loan system module 225 interacts with other modules to perform reporting functions and other transfer data. These modules include a marketing module 260, bank financial control module 265, and bank analytics module 270. For example, the marketing module 260 may use the data to develop marketing collateral that provides statistics on the success of the program (such as, “Participants in the program save an average of $50 per month.”). The bank financial control module 265 and bank analytics module 270 provide support functions for financial institution activities.

FIG. 3 provides a flow diagram depicting the process flow 300 for providing a discounted loan in connection with an insurance product in accordance with an exemplary embodiment of the present invention. Referring to FIGS. 1, 2a, 2b, and 3, the ILA module 205 receives loan application data from the loan application input module 230. The ILA module 205 uses these data to develop a loan application for a specific property item, such as an automobile or a house.

The data from the loan application input module 230 may be generated by an agent or insurance sales representative using the insurance workstation 120 or personal computer 135 and entering information provided by the customer. Alternatively, the data from the loan application input module 230 may be generated from a customer entering the data into a web interface using the personal computer 145, tablet 150, or other computing device (smartphone, kiosk, etc.—not shown).

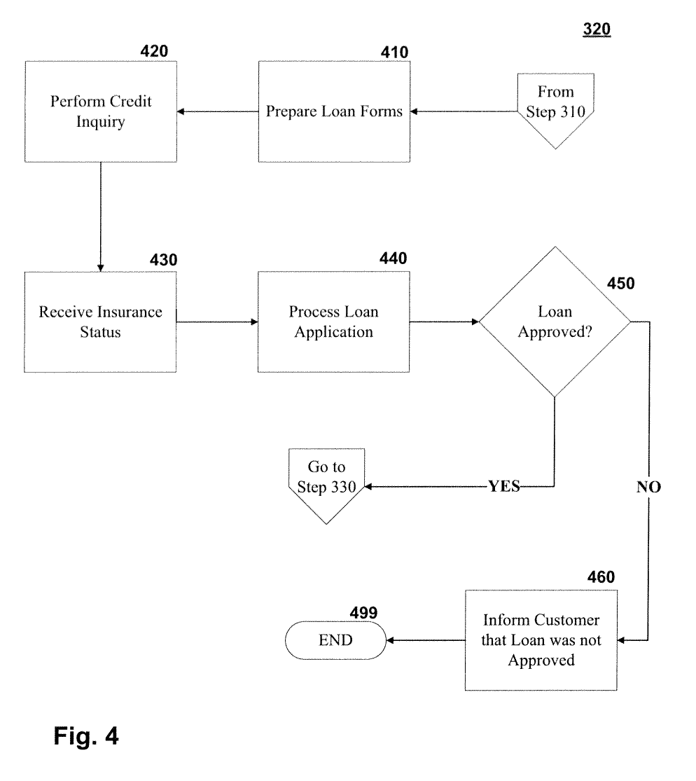

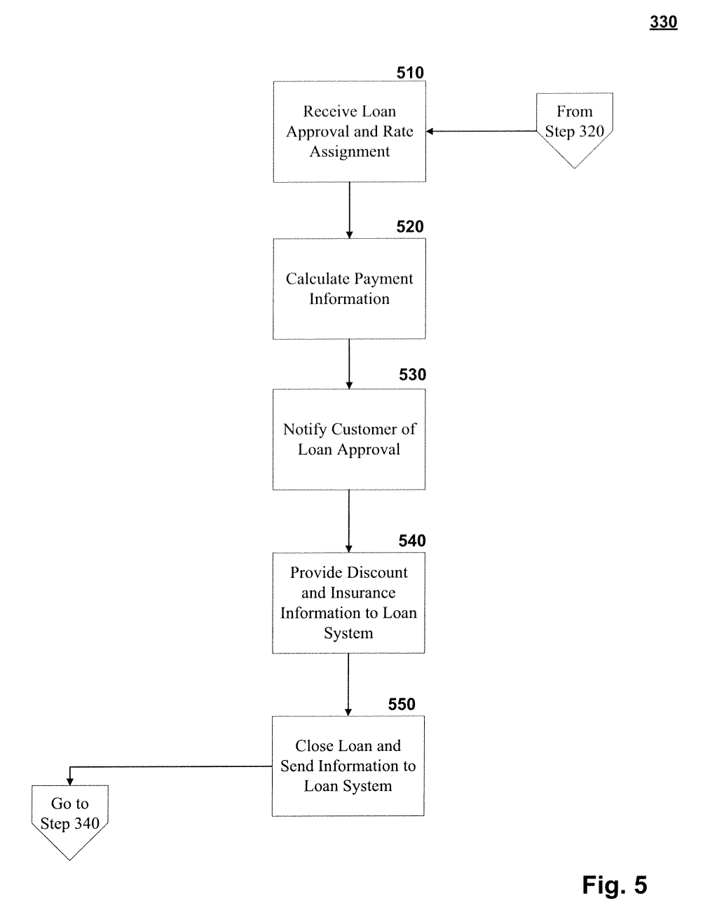

At step 320, the loan underwriting module 210, in connection with other modules, makes a loan underwriting decision. This step is described in greater detail below, in conjunction with FIG. 4. At step 330, the ILA module 205 and the loan underwriting module 210, in connection with other modules, determines the loan discount and records the closing of the loan. This step is described in greater detail below, in conjunction with FIG. 5. At step 340, the loan system module 225, in connection with other modules, administers the closed loan. This step is described in greater detail below, in conjunction with FIG. 6.

In one embodiment, the loan discount determination and administration can be triggered by an insurance inquiry at step 305. In this embodiment, a customer inquires with the insurance provider about obtaining an insurance quote for property that is being purchased by the customer. For example, a potential customer contacts an insurance provider by entering an inquiry into a web interface using the personal computer 145, tablet 150, or other computing device (smartphone, kiosk, etc.—not shown), such as to obtain a quote on an insurance product for an automobile the customer is purchasing. The insurance processing computer 125 may determine that the customer qualifies for a discount on a loan for that automobile and, in connection with providing a quote, the customer is provided the opportunity to apply for a loan with a discounted interest rate. The customer enters data into a web interface using the personal computer 145, tablet 150, or other computing device (smartphone, kiosk, etc.—not shown) necessary to complete the loan application as prompted by the loan application input module 230. Similarly, the customer may be provided the opportunity to apply for a loan with a discounted rate even if the customer already has secured financing for the property. In this case, the offered loan may provide more favorable terms than the loan already secured by the customer, such that the customer would take the new loan offer and pay off the loan previously obtained by the customer. For example, the customer could have secured financing for a new car through an automobile dealership where the customer purchased a vehicle. The customer could still benefit from a loan with better financial terms, such that the customer would refinance the vehicle loan, thus having an incentive to purchase an insurance product.

As discussed previously, a discount on a loan can be in connection with a variety of scenarios for purchasing an insurance product. In one case, the discount is offered to new customers of the insurance provider. Further, the discount could be related to the customer's previous insurance vendor, such that a larger discount is offered to customers that switch from certain competitors. Also, the discount could be offered to existing customers that expand their insurance coverage. For example, a returning automobile insurance customer may still receive a discount on an auto loan if that customer becomes a first-time purchaser of home or other insurance from the insurance provider.

FIG. 4 provides a flow diagram depicting the process flow 320 for making an underwriting decision associated with providing a discounted loan in connection with an insurance product in accordance with an exemplary embodiment of the present invention. Referring to FIGS. 1, 2a, 3, and 4 at step 410, the ILA module 205 prepares loan forms. In this step, the ILA module 205 accesses the forms warehouse 235 to receive the appropriate loan forms. The appropriate loan forms will depend on the type of loan. For example, forms for an automobile loan differ from forms for a mortgage. Once the forms are received, the ILA module 205 merges the data received at step 310 into the forms. At step 420, the ILA module 205 performs a credit inquiry, using personal identifying information obtained at step 310 and adds this data to the loan application form. In an alternative embodiment, this credit inquiry is performed at step 440, discussed below.

At step 430, the ILA module 205 accesses the policy management record 220 to determine the status of insurance associated with the loan applicant. The ILA module 205 supplies the policy management record 220 with an identifying number, such as a unique customer ID, a policy number, or a vehicle identification number. The policy management record 220 returns the status of a loan product that may serve as the basis for a discount. Based on this returned information, the ILA module 205 determines the availability of a loan interest rate discount for the customer and the magnitude of such a discount. In an alternative embodiment, this step is skipped and whether the customer qualifies for a discount and the magnitude of the discount is determined by the loan application input module 230 and is supplied to the ILA module 205 at step 310.

At step 440, the loan underwriting module 210 processes the loan application. In this step, the ILA module 205 supplies the loan underwriting module 210 with loan application and credit information. Included in the supplied information is whether the customer qualifies for a discount and the magnitude of the discount. In one embodiment, the credit information includes a credit score received in the inquiry at step 420. In an alternative embodiment, the credit information includes information sufficient for the loan underwriting module 210 to query one or more credit bureaus to receive a credit score or other indication of the creditworthiness of the applicant. The loan underwriting module 210 employs known algorithms to determine if the customer qualifies for a loan and at what interest rate.

At step 450, the ILA module 205 determines if the loan has been approved. This determination is based on approval information returned from the loan underwriting module 210. As discussed below in connection with FIG. 5, step 510, the loan underwriting module 210 also returns the interest rate for the loan, with the returned rate reflecting any applied discount. If the loan is approved, the process 300 moves to step 330. If the loan is not approved, the process 320 moves to step 460 and the ILA module 205 notifies the customer. This notification is through the loan application input module 230. The customer may receive the information by accessing the loan application input module 230 through a web interface using the personal computer 145, tablet 150, or other computing device (smartphone, kiosk, etc.—not shown). Alternatively, an agent using the insurance workstation 120 or personal computer 135 may receive a workflow item from the insurance processing computer 125 with the task to inform the customer. In another alternative, a representative of the financial institution may contact the customer. Following the notification, the process 320 moves to step 499 and ends.

FIG. 5 provides a flow diagram depicting the process flow 330 for determining a loan discount associated with providing a discounted loan in connection with an insurance product in accordance with an exemplary embodiment of the present invention. Referring to FIGS. 1, 2a, 2b, 3, and 5, at step 510, the ILA module 205 receives the loan approval information including the rate assignment. This rate reflects the discounted interest rate based on the discount for which the customer qualified.

At step 520, the loan calculator 215 calculates the periodic (such as monthly) loan payment amount. This payment amount is based on the loan duration, the interest rate, and the amount of money borrowed. The loan calculator 215 receives the information used in the calculation from the ILA module 205 and returns the payment amount.

At step 530, the ILA module 205 notifies the customer that the loan has been approved. This notification is through the loan application input module 230. The customer may receive the information by accessing the loan application input module 230 through a web interface using the personal computer 145, tablet 150, or other computing device (smartphone, kiosk, etc.—not shown). Alternatively, an agent using the insurance workstation 120 or personal computer 135 may receive a workflow item from the insurance processing computer 125 with the task to inform the customer. In another alternative, a representative of the financial institution may contact the customer.

At step 540, the ILA module 205 provides the loan system module 225 with discount and insurance information associated with a specific loan. Provided information includes a customer identifier, such as a unique customer ID or loan number, the magnitude of any discount on the interest rate for the loan, and an indicator of the insurance policy that serves as the basis for the interest rate discount, such as the policy number.

At step 550, the loan underwriting module 210 receives an indication that the loan has been closed from the ILA module 205. The ILA module 205 receives this information from input provided by a financial institution representative using the loan processing workstation 110. In response to this indication, the loan underwriting module 210 sends information on the closed, or booked, loan to the loan system module 225. The process 300 then moves to step 340.

FIG. 6 provides a flow diagram depicting the process flow 340 for maintaining a loan associated with providing a discounted loan in connection with an insurance product in accordance with an exemplary embodiment of the present invention. Referring to FIGS. 1, 2a, 2b, and 6, at step 610, the loan system module 225 receives information on the booked loan from the loan underwriting module 210 and information on any discount associated with the loan and the insurance policy underlying the discount from the ILA module 205.

At step 620, the loan system module 225 provides the bank financial control system 265 with information on the loan, including any discount to the interest rate and the underlying insurance policy number. The bank financial control system 265 administers the loan, including the routine processes required to maintain the loan.

At step 630, the loan system module 225 periodically provides the amount of the loan discount to the general ledger 255, such as on a monthly basis. The loan interest rate discount is given to a customer as an incentive to purchase (and retain) an insurance product from an insurance provider. The insurance provider provides this incentive in return for the opportunity to service a new customer or to sell additional insurance products to an existing customer. However, the financial institution ultimately provides the incentive to the customer, in the form of a reduced monthly payment on a loan. Accordingly, the financial institution essentially loses money from each loan payment associated with the loan discount. Since the ultimate beneficiary of the discount program is the insurance provider, this loss is covered by the insurance provider, which pays the financial institution a sum to cover the difference in a loan payment associated with the discounted interest rate. The loan system module 225 tracts the money owned by the insurance provider to the financial institution by placing entries into the general ledger 255.

At step 640, the loan system module 225 determines whether the insurance policy that serves as the basis for a loan interest rate discount is still in force. The phrase “still in force,” means that an issued insurance policy has not been canceled, either by the policy holder or the insurance provider. At this step, the loan system module 225, through the ILA module 205, queries the policy manage record 220 to determine the status of the insurance policy that serves as the basis for the loan interest rate discount. If the insurance policy is still in force, the process 340 moves to step 650. If the insurance policy is not in force, the process 340 moves to step 660. At step 660, the loan system module 225 updates the bank financial control system 265 with the change in the status of the insurance policy that served as the basis for the interest rate discount. The bank financial control system 265 recalculates the loan payment based on an undiscounted interest rate, and applies that new payment to the loan. From this point on, the customer must pay the increased payment amount. This new payment reflects what the installment loan payment would have been if no discount was applied at the start and the increased payment is applied going forward. In this case, the customer was able to have a reduced loan payment until he or she canceled the insurance policy. In an alternative embodiment, the loan payment is increased to a level to recoup the amount of the discount already provided to the customer as well as reflecting the loan payment without a discount.

At step 650, the loan system module 225 determines if the loan is paid in full. If this determination is “yes,” the process 340 moves to step 699 and terminates. If this determination is “no,” the process 340 returns to step 630 and repeats the steps of process 340 on a periodic basis from that point in the process.

In other words, each month (or other appropriate time period), the loan system module 225 determines if the insurance policy is still in force and, if it is, records in the general ledger 255 the amount owed by the insurance provider to the financial institution due to the applied discount—the reduced amount of money paid by the customer because of the incentive interest rate discount. If the insurance policy is not in force, the discount is removed and the loan payment recalculated to reflect the higher payment. Of course, when the loan is paid off, there is no longer a need to track the discount.

For the purposes of this disclosure, the term exemplary means example only. Although the disclosed embodiments are described in detail in the present disclosure, it should be understood that various changes, substitutions and alterations can be made to the embodiments without departing from their spirit and scope.

1. A computer network-based method for automatically providing a discounted interest rate for a loan from a loan provider for acquiring a property, comprising the steps of:
determining, by a computer of the loan provider, an interest rate discount for the loan based on a loan applicant purchasing an insurance product from an insurance provider covering the property;
receiving, by the computer of the loan provider, via a computer network, information from a remote computer of a credit entity, credit information of the loan applicant regarding a creditworthiness of the loan applicant;
determining, by the computer of the loan provider, a discounted interest rate for the loan based on the received credit information of the loan applicant, a baseline interest rate, and the determined interest rate discount;
making, by the computer of the loan provider, an underwriting decision approving the loan based on the determined discounted interest rate;
determining, by the computer of the loan provider, a periodic payment amount based on the determined discounted interest rate; and
automatically administering, by the computer of the loan provider, the loan, comprising:
automatically requesting, collecting, and processing periodic payments of the periodic payment amount during a first portion of a term of the loan, wherein each periodic payment defines a loss to the insurance provider due to the discounted interest rate;
automatically determining and recording, for each periodic payment, an amount owed by the insurance provider to the loan provider to account for the loss to the insurance provider;
periodically automatically accessing from a database server, by the computer of the loan provider, a status record indicating a current status of the purchased insurance product, and determining based on the accessed status record, by the computer, that the purchased insurance product is not in force; and
in response to determining that the purchased insurance product is not in force:
calculating, by the computer of the loan provider, an increased periodic payment amount based on the baseline interest rate and without considering the interest rate discount; and
requesting, collecting, and processing periodic payments of the increased periodic payment amount for a remaining portion of the term of the loan, wherein the increased periodic payment amount is not enforced retroactively.

2. The method of claim 1 further comprising the step of: receiving, at a computer, data comprising information for a loan application for the loan.

3. The method of claim 2 further comprising the steps of:
providing, by the computer, a first interface for receiving information from the loan applicant; and
during the term of the loan, providing, by the computer, a second interface for informing the loan applicant about a status of the loan.

4. The method of claim 3 wherein the first interface and the second interface comprise a web page.

5. The method of claim 1 wherein the step of determining, by the computer, an interest rate discount based on a loan applicant purchasing an insurance product further comprises determining if the loan applicant is a new customer of an entity providing the insurance product.

6. The method of claim 1 wherein the step of determining, by the computer, the discounted interest rate for the loan based on the creditworthiness of the loan applicant and the determined discounted interest rate discount further comprises determining the interest rate discount based on an entity that provided a previously-purchased insurance product purchased by the loan applicant.

7. The method of claim 1 wherein the step of administering, by the computer, the loan further comprises the step of periodically recording, by the computer, an amount of money associated with a discounted payment, wherein the amount of money is the difference between the periodic payment with the interest rate discount and a periodic payment without the interest rate discount.

8. The method of claim 7 wherein the computer notifies the entity providing the insurance product of the recorded amount of money.

9. A computer network-based system for automatically providing a discounted interest rate for a loan from a loan provider for acquiring a property, the system comprising:
an installment loan application module of the loan provider comprising computer instructions stored in non-transitory computer-readable media and executable by one or more processors to:
determine an interest rate discount based on a loan applicant purchasing an insurance product from an insurance provider covering the property;
receive, by the computer, via a computer network, information from a remote computer of a credit entity, credit information of the loan applicant regarding a creditworthiness of the loan applicant;
determine a discounted interest rate for the loan based on the received credit information of the loan applicant, a baseline interest rate, and the determined interest rate discount;
make an underwriting decision approving the loan based on the determined discounted interest rate; and
determine a periodic payment amount based on the determined discounted interest rate; and
a loan system module of the loan provider comprising computer instructions stored in non-transitory computer-readable media and executable by one or more processors to
automatically administer the loan, comprising:
requesting, collecting, and processing periodic payments of the periodic payment amount during a first portion of a term of the loan, wherein each periodic payment defines a loss to the insurance provider due to the discounted interest rate;
automatically determining and recording, for each periodic payment, an amount owed by the insurance provider to the loan provider to account for the loss to the insurance provider;
periodically automatically accessing from a database server a status record indicating a current status of the purchased insurance product, and determining based on the accessed status record, by the computer, that the purchased insurance product is not in force; and
in response to determining that the purchased insurance product is not in force:
calculating an increased periodic payment amount based on the baseline interest rate and without considering the interest rate discount; and
requesting, collecting, and processing periodic payments of the increased periodic payment amount during a remaining portion of the term of the loan.

10. The system of claim 9 wherein the installment loan application module is further programmed to receive data comprising information for a loan application for the loan from the loan applicant.

11. The system of claim 10 wherein the installment loan application module is further programmed to:
provide a first interface for receiving information from the loan applicant; and
during the term of the loan, provide, a second interface for informing the loan applicant about a status of the loan.

12. The system of claim 11 wherein the first interface and the second interface comprise a web page.

13. The system of claim 9 wherein the programmed process to determine an interest rate discount based on the loan applicant purchasing an insurance product further comprises a programmed process to determine if the loan applicant is a new customer of an entity providing the insurance product.

14. The system of claim 9 wherein the programmed process to determine the interest rate for the loan based on the creditworthiness of the loan applicant and the determined discounted interest rate discount further comprises a programmed process to determine the discounted interest rate discount based on an entity that provided a previously-purchased insurance product purchased by the loan applicant.

15. The system of claim 9 wherein the programmed process to administer the loan further comprises the programmed process to periodically record an amount of money associated with a discounted payment, wherein the amount of money is the difference between the periodic payment with the interest rate discount and the periodic payment without the interest rate discount.

16. The system of claim 15 wherein the computer notifies the entity providing the insurance product of the recorded amount of money.

17. A computer network-based method for automatically providing a discounted interest rate for a loan from a loan provider for acquiring a property, comprising the steps of:
providing, by a computer of the loan provider, a first interface for receiving information from a loan applicant;
receiving, at the computer of the loan provider, via a computer network, data comprising information for a loan application for the loan provided by the loan applicant;
determining, by the computer, an interest rate discount based on the loan applicant purchasing an insurance product from an insurance provider covering the property;
receiving, at the computer, via the computer network, from a remote computer of a credit entity, credit information of the loan applicant regarding a creditworthiness of the loan applicant;
determining, by the computer of the loan provider, a discounted interest rate for the loan based on the received credit information of the applicant and the determined interest rate discount;
making, by the computer of the loan provider, an underwriting decision approving the loan based on the determined discounted interest rate;
determining, by the computer of the loan provider, a periodic payment amount based on the determined discounted interest rate;
providing, by the computer of the loan provider, a second interface for informing the loan applicant about the status of the loan; and
automatically administering, by the computer of the loan provider, the loan, comprising:
requesting, collecting, and processing periodic payments of the periodic payment amount during a first portion of a term of the loan, wherein each periodic payment defines a loss to the insurance provider due to the discounted interest rate;
automatically determining and recording, for each periodic payment, an amount owed by the insurance provider to the loan provider to account for the loss to the insurance provider;
periodically automatically accessing from a database server, by the computer of the loan provider, a status record indicating a current status of the purchased insurance product, and determining based on the accessed status record, by the computer of the loan provider, that the purchased insurance product is not in force;
in response to determining that the purchased insurance product is not in force:
calculating, by the computer of the loan provider, an increased periodic payment amount based on the baseline interest rate and without considering the interest rate discount; and
requesting, collecting, and processing periodic payments of the increased periodic payment amount during a remaining portion of the term of the loan.

18. The method of claim 17 wherein the step of determining, by the computer, an interest rate discount based on the loan applicant purchasing an insurance product further comprises determining if the applicant is a new customer of an entity providing the insurance product.

19. The method of claim 17 wherein the step of administering, by the computer, the loan further comprises the step of periodically recording, by the computer, an amount of money associated with a discounted payment, wherein the amount of money is the difference between the periodic payment with the interest rate discount and the periodic payment without the interest rate discount.

20. The method of claim 19 wherein the computer notifies the entity providing the insurance product of the recorded amount of money.

21. A computer network-based system for automatically providing a discounted interest rate for a loan from a loan provider for acquiring a property, the system comprising:
means for determining an interest rate discount based on a loan applicant purchasing an insurance product from an insurance provider covering the property;
means for collecting, via a computer network, credit information of the loan applicant regarding a creditworthiness of the loan applicant;
means for determining a discounted interest rate for the loan based on the received credit information of the loan applicant, a baseline interest rate, and the determined interest rate discount;
means for making an underwriting decision approving the loan based on the determined discounted interest rate;
means for determining a periodic payment amount based on the determined discounted interest rate; and
means for automatically requesting, collecting, and processing periodic payments of the periodic payment amount during a term of the loan, wherein each periodic payment defines a loss to the insurance provider due to the discounted interest rate;
means for automatically determining and recording, for each periodic payment, an amount owed by the insurance provider to the loan provider to account for the loss to the insurance provider;
means for, during the term of the loan, periodically automatically accessing from a database server a status record indicating a current status of the purchased insurance product, and determining based on the accessed status record, that the purchased insurance product is not in force;
means for calculating, in response to determining that the purchased insurance product is not in force, an increased periodic payment amount based on the baseline interest rate and without considering the interest rate discount; and
means for requesting, collecting, and processing periodic payments of the increased periodic payment amount during a remaining portion of the term of the loan.
